(19) United States
(12) Patent Application Publication
(10) Pub. No.: US 2007/0204586 A1
(43) Pub. Date: Sep. 6, 2007

(54) Knife drive for multiple cutterbars in an agricultural machine

(75) Inventor: Bruce Alan Coers, Hillsdale, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/366,030

(22) Filed: Mar. 2, 2006

(51) Int. Cl. A01D 34/03

(52) U.S. Cl. 56/16.9

(57) ABSTRACT

A cutting platform for an agricultural machine, such as a combine, includes a first cutterbar having a first drive end, and a second cutterbar having a second drive end generally longitudinally spaced from the first drive end. A knife drive has an input, a first output coupled with the first drive end and a second output coupled with the second drive end.

### FIELD OF THE INVENTION

The present invention relates to agricultural machines including a reciprocating cutterbar, and, more particularly, to such a machine including multiple cutterbars.

### BACKGROUND OF THE INVENTION

An agricultural harvesting machine such as a combine includes a head and a feeder housing which remove the crop material from the field, gather the crop material and transport the crop material to a separator. In the case of thinner stemmed crops such as soybeans, wheat, etc. which may be cut with a sickle bar carrying a plurality of knives, the head may also be known as a cutting platform. The separator removes the grain crop material from the non-grain crop material. The grain is cleaned and deposited in a grain tank. When the grain tank becomes full, an unloading auger which is positioned alongside the combine during harvesting is moved to the unloading position in which the auger extends approximately perpendicular to the longitudinal axis of the combine. The combine drives alongside a vehicle into which the grain is to be unloaded, such as a semi-trailer, and the unloading auger is actuated to discharge the grain into the vehicle.

A cutting platform may generally be of two types. One type typically has a sheet metal floor with a dual feed auger near the rear of the cutting platform for feeding the crop material longitudinally to the feeder housing. A cutting platform of this type with auger feed is more common.

Another type of cutting platform, also known as a draper platform, utilizes a flat, wide belt, referred to as a draper or draper belt to convey crop material. The arrangement and number of belts vary among platforms. One style of draper platform has two side belts that convey crop material longitudinally, to the center of the platform, where a center feed belt moves the crop material laterally into the feeder housing. Each belt is wrapped around a pair of rollers, one being a drive roller and the other being an idler roller. An example of this type draper arrangement is disclosed in U.S. Pat. No. 6,202,397, which is assigned to the assignee of the present invention.

An advantage of a draper platform is that larger amounts of crop material can be transported without plugging, etc. For example, with wide platforms approaching 40 feet or even larger, the amount of crop material transported to the feeder housing can be substantial. With an auger feed platform, the crop material may bind between the auger and the back wall of the platform. In contrast, with a draper platform, the crop material is carried on top of the belt with less chance for plugging.

Draper platforms currently in use have a rigid framework not allowing the framework to flex to any appreciable extent during use. The draper platform can be placed in a “float” position such that the cutterbar at the leading edge does not dig into the ground, but the leading edge of the platform itself cannot flex across the width of the platform as a result of uneven ground terrain. This results in some crop material being missed in ground depressions, etc., while also possibly causing a part of the cutterbar to dig into localized ground elevations (e.g., small mounds, etc.). Of course, missed crop material directly translates into missed revenue, and localized gouging of soil can cause additional repair expenses resulting from broken knives, knife guards, etc.

With newer agricultural equipment, including harvesters such as draper platforms, the tendency is to provide wider equipment which can cover more ground in a smaller amount of time. A draper platform as described above may approach 40 feet in width, or even wider. It is difficult if not impossible to reciprocally drive a single cutterbar of this length from one end of the platform.

It is known to provide a cutting platform with 2 cutterbars which are driven from opposite ends of the platform. It is thus necessary to route drive components, usually shafts, sprockets and chains, to the extreme outboard ends of the cutting platform. This adds cost and weight to the cutting platform. Further, the cutterbars are typically not timed with each other which can result in undue vibrations in the cutting platform.

What is needed in the art is a wide draper platform with a sickle cutter assembly which is more easily driven and which propagates less vibrations.

### SUMMARY OF THE INVENTION

The invention comprises, in one form thereof, a cutting platform for an agricultural machine, such as a combine. A first cutterbar has a first drive end, and a second cutterbar has a second drive end generally longitudinally spaced from the first drive end. A knife drive has an input, a first output coupled with the first drive end and a second output coupled with the second drive end.

### BRIEF DESCRIPTION OF THE DRAWINGS

FIG. 1 is a fragmentary, top view of an agricultural combine including an embodiment of a draper platform of the present invention;

FIG. 2 is a fragmentary, perspective view of the agricultural combine of FIG. 1;

FIG. 3 is a fragmentary, perspective view of the cutting platform shown in FIGS. 1 and 2 illustrating an embodiment of a single knife drive for multiple cutterbars;

FIG. 4 is a fragmentary, top view of a cutting platform with another embodiment of a single knife drive for multiple cutter bars; and

FIG. 5 is a fragmentary, top view of a cutting platform including yet another embodiment of a single knife drive for multiple cutterbars of the present invention.

### DETAILED DESCRIPTION OF THE INVENTION

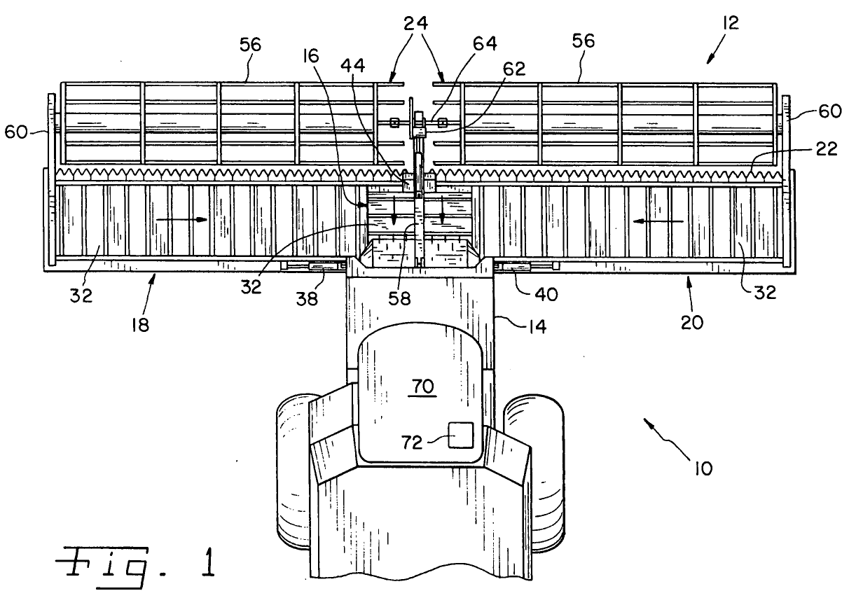

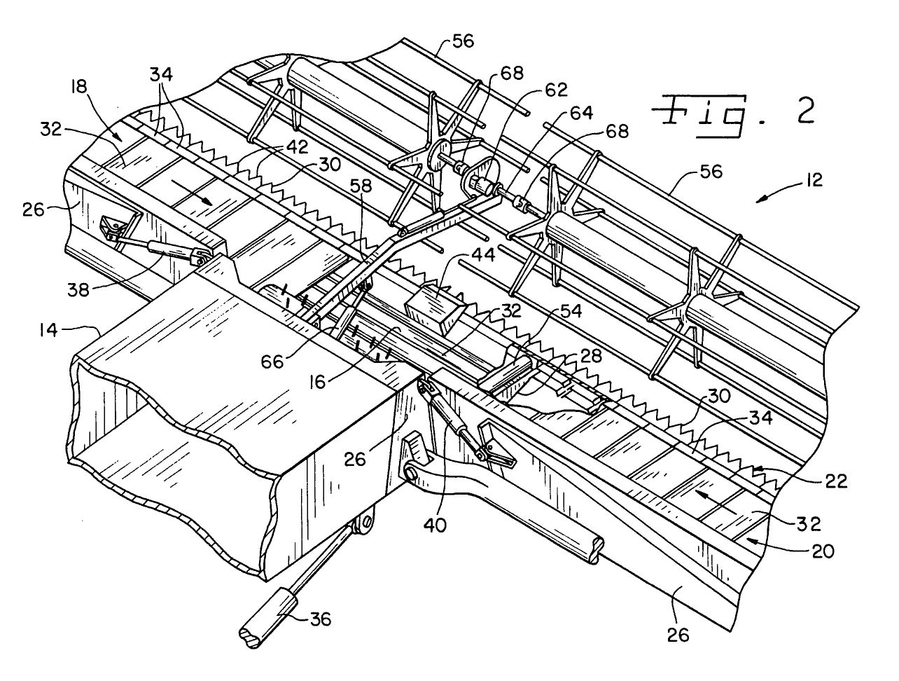

Referring now to the drawings, and, more particularly to FIGS. 1 and 2, there is shown an agricultural harvesting machine in the form of a combine 10 including an embodiment of a cutting platform 12 of the present invention. Combine 10 includes a feeder housing 14 which is detachably coupled with cutting platform 12. Feeder housing 14 receives the crop material from cutting platform 12, both grain and non-grain crop material, and transports the crop material to a separator within combine 10 in known manner (not shown). The grain crop material is separated from the non-grain crop material, cleaned and transported to a grain tank. The non-grain crop material is transported to a chopper, blower, etc. in known manner and distributed back to the field.

Cutting platform 12 generally includes a plurality of platform sections 16,18 and 20, a cutterbar assembly 22 and a reel assembly 24. In the embodiment shown, platform section 16 is a center platform section, platform section 18 is a first wing platform section, and platform section 20 is a second wing platform section. Although shown with three platform sections, cutting platform 12 may be configured with more or less platform sections, depending upon the particular application.

Each platform section 16, 18 and 20 generally includes a frame 26, a plurality of float arms 28 coupled with a respective frame 26, a cutterbar 30 carried by the outboard ends of respective float arms 28, an endless belt 32, and a plurality of belt guides 34. The frame 26 of first wing platform section 18 and second wing platform section 20 are each pivotally coupled with center platform section 16, such that the outboard ends of first wing platform section 18 and second wing platform section 20 can move up and down independent from center platform section 16. To that end, a lift cylinder 36 coupled between the frame of combine 10 and feeder housing 14 lifts the entire cutting platform 12, a first tilt cylinder 38 coupled between the respective frame 26 of first wing platform section 18 and center platform section 16 pivotally moves first wing platform section 18 relative to center platform section 16, and a second tilt cylinder 40 coupled between the respective frame 26 of second wing platform section 20 and center platform section 16 pivotally moves second wing platform section 20 relative to center platform section 16.

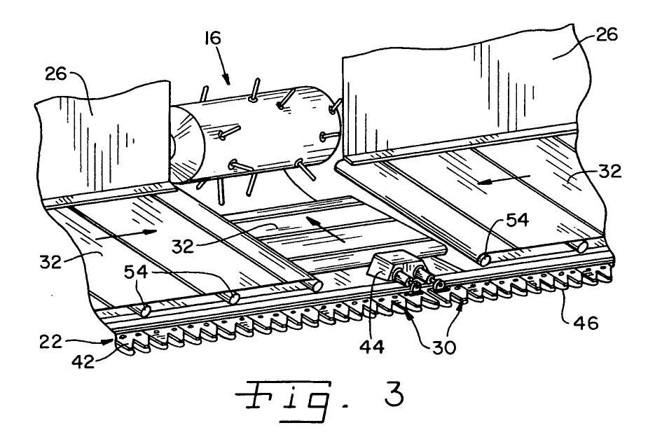

Cutterbar assembly 22 includes two cutterbars 30 carried at the outboard ends of float arms 28 (i.e., at the leading edge of a platform section 16, 18 or 20). Each cutterbar 30 includes a plurality of knives 42 carried by a bar (not specifically shown). The particular type of knife can vary, such as a double blade knife (as shown in FIG. 3) or a single blade knife. The bar is formed from a metal which is flexible to an extent allowing a desired degree of flexure across the width of cutting platform 12. In the embodiment shown, a majority of each cutterbar 30 is carried by a respective first wing platform section 18 or second wing platform section 20, with a lesser extent at the adjacent inboard ends of each cutterbar 30 being carried by center platform section 16. Cutterbars 30 are simultaneously driven by a single knife drive 44, providing reciprocating movement in concurrent opposite directions between cutterbars 30. A plurality of knife guards 46 are positioned in opposition to knives 42 for providing opposing surfaces for cutting the crop material with knives 42.

Float arms 28 may be pivoted at their connection locations with a respective frame 26. A float cylinder 50 coupled between a respective frame 26 and float arm 28 may be used for raising or lowering the outboard end of float arm(s) 28 at the leading edge of cutting platform 12. Each float cylinder 50 may also be placed in a “float” position allowing the connected float arm 28 to generally follow the ground contour during operation. In this manner, the rams associated with each float cylinder 50 are free to move back and forth longitudinally, thereby allowing float arms 28 to follow the ground contour. When not in a float mode, float cylinders 50 can be actuated to move float arms 28 in an upward or downward direction. In the embodiment shown, each float cylinder 50 is a one-way hydraulic cylinder, but could possibly be configured as a gas cylinder for a particular application.

Each float arm 28 is also associated with a respective roller 54. The plurality of rollers 54 for each platform section 16,18 and 20 carry and are positioned within a loop of a respective endless belt 32. At the inboard end of first wing platform section 18 and second wing platform section 20 is a driven roller, and at the outboard end of first wing platform section 18 and second wing platform section 20 is an idler roller. The rollers positioned between the inboard drive roller and outboard idler roller at each float arm 28 also function as idler rollers. It will be appreciated that the number of float arms 28, and thus the number of rollers 54, may vary depending upon the overall width of cutting head 12 transverse to the travel direction.

Reel assembly 24 includes two reels 56, center reel support arm 58 and a pair of outer reel support arms 60. Outer reel support arms 60 are pivotally coupled at one end thereof with an outboard end of a respective first wing platform section 18 or second wing platform section 20. Outer reel support arms 60 rotationally carry a respective reel 56 at an opposite end thereof. Each outer reel support arm 60 may be selectively moved up and down using a hydraulic cylinder, and the pair of hydraulic cylinders are typically coupled in parallel so that they move together upon actuation.

Center reel support arm 58 is pivotally coupled at one end thereof with center platform section 16 above the opening leading to feeder housing 14. Center reel support arm 58 rotationally carries an inboard end of each reel 56 at an opposite end thereof. A hydraulic motor 62 or other suitable mechanical drive rotationally drives each reel 56. More particularly, hydraulic motor 62 drives a common drive shaft 64 through a chain and sprocket or other suitable arrangement (not shown). The rotational speed of reels 56 can be adjusted by an operator by adjusting the rotational speed of hydraulic motor 62.

Center reel support arm 58 may be selectively moved up and down using a hydraulic cylinder 66. Center reel support arm 58 is movable independently from outer reel support arms 60. To accommodate this independent movement, drive shaft 64 driven by hydraulic motor 62 is coupled at each end thereof via a universal joint 68 with a respective reel 56. This independent movement of center reel support arm 58 can be accomplished manually using a separate actuating switch or lever in operator's cab 70, or automatically using an electronic controller 72 located within cab 70 or other suitable location.

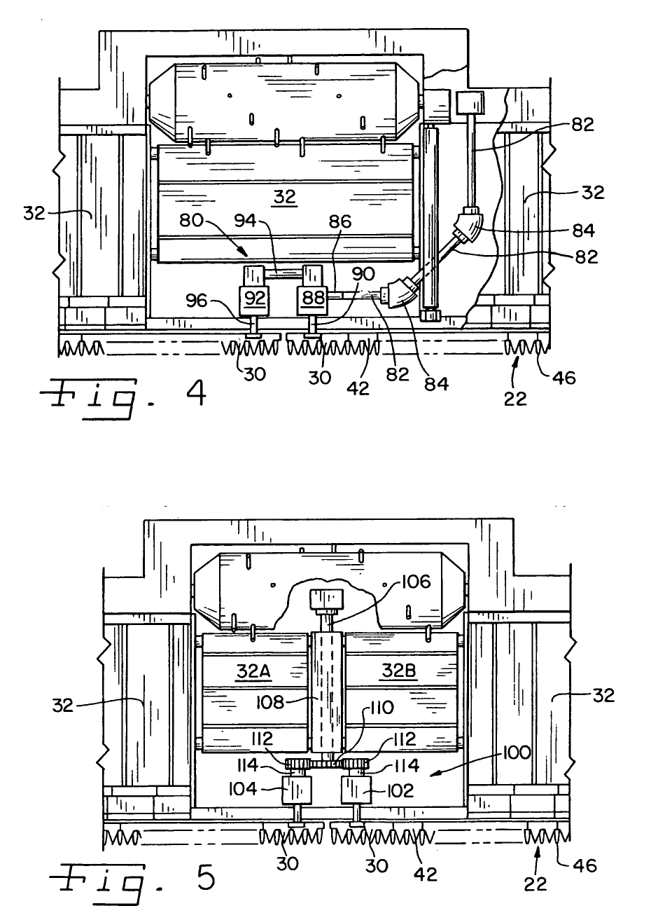

Referring now to FIG. 3, knife drive 44 will be described in greater detail. Knife drive 44 generally receives rotational input power and provides two reciprocating, translational power outputs for driving the two cutterbars 30 in reciprocating, opposite directions. More particularly, knife drive 44 includes a rotational input shaft (not shown) and a pair of translational output shafts 74. Each output shaft 74 is coupled with a corresponding cutter bar 30 in any suitable manner, such as by using fasteners, welding, etc. As will be more apparent with regard to the description of FIGS. 4 and 5 below, the manner in which knife drive 44 receives rotational input power can vary depending upon the application. For example, a combination of gears, sprockets, pulleys, drive shafts, chains and/or belts may be used to transfer rotational power from the power takeoff shaft near the rear of cutting platform 12 adjacent combine 10 to the input shaft of knife drive 44. Power may be transferred under or along side of endless belt 32 of center platform section 16. Moreover, for certain applications, it may be possible or necessary to split endless belt 32 of center platform section 16 to accommodate the power transfer to knife drive 44.

Referring now to FIG. 4, another embodiment of a single knife drive 80 for driving the pair of cutterbars 30 is shown. Knife drive 80 includes three drive shafts 82 which are coupled together by a pair of 450 gear boxes 84. The downstream drive shaft 82 is coupled with input shaft 86 of gear case 88 which reciprocally drives the right hand cutterbar 30 shown in FIG. 4. More particularly, gear case 88 has an output shaft 90 which is coupled with and reciprocally drives the right hand cutterbar 30. Gear case 88 is coupled with gear case 92 via an intervening gear 94. Gear case 92 likewise has an output shaft 96 which is coupled with and reciprocally drives the left hand cutterbar 30 shown in FIG. 4. Because of the geared interconnection between gear boxes 88 and 92, the movement of the two cutterbars 30 are timed relative to each other. Preferably, cutterbars 30 are timed with a reciprocating motion such that they move in opposite directions relative to each other and reach the zero velocity changes in direction at approximately the same points in time. In this manner, vibrations are reduced which could affect the operation of the cutting platform.

Referring now to FIG. 5, yet another embodiment is shown of a single knife drive 100 for driving the pair of cutterbars 30. Similar to knife drive 80 shown with respect to FIG. 4, knife drive 100 also includes a pair of gear boxes 102 and 104 which are respectively coupled with and reciprocally drive the pair of cutterbars 30. The primary difference is that an input drive shaft 106 extends generally through the central area occupied by endless belt 32 shown in FIG. 4. Thus, it is necessary to split the endless belt of the center platform section into two endless belts 32A and 32B on either side of input drive shaft 106. A cover 108 is positioned over drive shaft 106 such that crop material does not interfere with the operation thereof. At the distal end of drive shaft 106 is a gear 110 which is positioned between and concurrently drives mating gears 112 associated with gear boxes 102 and 104. Gears 112 are each mounted at the distal end of an input shaft 114 associated with each respective gear box 102 and 104. As described above, gear boxes 102 and 104 are reciprocally driven in a timed and oppositely reciprocating manner.

In the embodiment of knife drive 100 shown in FIG. 5, gear boxes 102 and 104 are each configured as an off-the-shelf gear box which converts a rotational input to a translational output. One such gear box is manufactured by the Assignee of the present invention, namely, John Deere Part No. DE 19264. Other types of gear boxes are also commercially available having rotational inputs and translational outputs. Additionally, primarily depending upon space limitations for a particular application, it may be possible to use a short coupled pitman arm arrangement.

Although the single knife drive of the present invention is shown for use with a draper cutting platform, it is to be understood that the single knife drive of the present invention can be used with other types of wide agricultural cutters employing two cutterbars arranged generally in axial alignment and/or in end-to-end relation to each other.

Having described the preferred embodiment, it will become apparent that various modifications can be made without departing from the scope of the invention as defined in the accompanying claims.

1. A cutting platform for an agricultural machine, comprising:
a first cutterbar having a first drive end;
a second cutterbar having a second drive end generally longitudinally spaced from said first drive end; and
a knife drive having an input, a first output coupled with said first drive end and a second output coupled with said second drive end, said cutting platform comprising a draper platform.

2. The cutting platform of claim 1, wherein said knife drive reciprocally drives each of said first cutterbar and said second cutterbar in opposite directions relative to each other during operation.

3. The cutting platform of claim 1, wherein said first drive end and said second drive end are longitudinally adjacent each other, and said knife drive is positioned adjacent each of said first drive end and said second end.

4. The cutting platform of claim 1, wherein said input comprises a rotational input and each of said first output and said second output comprise translational outputs.

5. The cutting platform of claim 4, wherein said input comprises an input shaft.

6. The cutting platform of claim 5, wherein said first output and said second output each comprise an output shaft.

7. (canceled)

8. An agricultural harvesting machine, comprising:
a feeder housing; and
a cutting platform carried by said feeder housing, said cutting platform including:
a first cutterbar having a first drive end;
a second cutterbar having a second drive end generally longitudinally spaced from said first drive end; and
a knife drive having an input, a first output coupled with said first drive end and a second output coupled with said second drive end, said cutting platform comprising a draper platform.

9. The agricultural harvesting machine of claim 8, wherein said knife drive reciprocally drives each of said first cutterbar and said second cutterbar in opposite directions relative to each other during operation.

10. The agricultural harvesting machine of claim 8, wherein said first drive end and said second drive end are longitudinally adjacent each other, and said knife drive is positioned adjacent each of said first drive end and said second end.

11. The agricultural harvesting machine of claim 8, wherein said input comprises a rotational input and each of said first output and said second output comprise translational outputs.

12. The agricultural harvesting machine of claim 11, wherein said input comprises an input shaft.

13. The agricultural harvesting machine of claim 12, wherein said first output and said second output each comprise an output shaft.

14-18. (canceled)
